(19) United States
(12) Patent Application Publication
(10) Pub. No.: US 2024/0212272 A1
(43) Pub. Date: Jun. 27, 2024

(54) INTERACTIONS BASED ON MIRROR DETECTION AND CONTEXT AWARENESS

(71) Applicant: APPLE INC., Cupertino, CA (US)

(72) Inventors: Brian W. TEMPLE, Santa Clara, CA (US); Devin W. CHALMERS, Oakland, CA (US); Rahul NAIR, Hayward, CA (US); Thomas G. SALTER, San Francisco, CA (US)

(21) Appl. No.: 18/599,297

(22) Filed: Mar. 8, 2024

Related U.S. Application Data
(63) Continuation of application No. PCT/US2022/042684, filed on Sep. 7, 2022.
(60) Provisional application No. 63/246,079, filed on Sep. 20, 2021.

(51) Int. Cl. G06T 17/00; G06V 40/16

(52) U.S. Cl. CPC G06T 17/00; G06V 40/168; G06V 40/172; G06V 2201/07

(57) ABSTRACT

Various implementations disclosed herein include devices, systems, and methods that present virtual content based on detecting a reflection and determining the context associated with a use of the electronic device in the physical environment. For example, an example process may include obtaining sensor data from one or more sensors of the electronic device in a physical environment that includes one or more objects, detecting a reflected image amongst the one or more objects based on the sensor data, and in accordance with detecting the reflected image, determining a context associated with a use of the electronic device in the physical environment based on the sensor data, and presenting virtual content based on the context, wherein the virtual content is positioned at a three-dimensional (3D) location based on a 3D position of the reflected image.

### CROSS-REFERENCE TO RELATED APPLICATIONS

This patent application is a continuation of International Application No. PCT/US2022/042684 (International Publication No. WO 2023/043647) filed on Sep. 7, 2022, which claims priority of U.S. Provisional Application No. 63/246,079 filed on Sep. 20, 2021, entitled “INTERACTIONS BASED ON MIRROR DETECTION AND CONTEXT AWARENESS,” each of which is incorporated herein by this reference in its entirety.

### TECHNICAL FIELD

The present disclosure generally relates to displaying content with electronic devices and, in particular, to systems and methods that present content in response to detecting a reflective surface and determining a context of a real-world physical environment.

### BACKGROUND

Electronic devices are often used to present users with views that include virtual content and content from surrounding physical environments. It may be desirable to provide a means of efficiently detecting appropriate times and locations to provide these views.

### SUMMARY

Various implementations disclosed herein include devices, systems, and methods that detect a reflective surface, such as a mirror (or a reflected portion of an object), and determine a context of a real-world physical environment, and in response, present an associated application based on the detected mirror and determined context. For example, a context may include a time of day (e.g., morning), and after detecting a reflected image based on one more mirror detection techniques, processes may include displaying information relevant to the user's day, such as a calendar, stocks, news, messages, weather, etc. Mirror detection techniques may include detecting and/or tracking facial regions over time. Mirror detection may involve comparing the location and relative angle of facial boundaries. Facial tracking may involve tracking the face/head of a user wearing an HMD and thus may involve tracking facial features and/or tracking HMD features. A mirror can also be detected based on object recognition using machine learning techniques. In cases where the user is looking at themselves in a mirror, the bounding rectangles can be contained in a specific region and will not show any rotation, even as the camera moves. Once it has been detected that a user is looking in a mirror, boundaries of a user's face can be detected with shape analysis as well as any boundaries of the tracked facial recognition in the region as the user moves in front of the tracked region of the mirror.

In some implementations, the virtual content may be provided in one or more different set of views to improve a user experience (e.g., while wearing a head mounted display (HMD)). Some implementations allow interactions with the virtual content (e.g., an application widget). In some implementations, a device (e.g., a handheld, laptop, desktop, or HMD) provides views of a three-dimensional (3D) environment (e.g., a visual and/or auditory experience) to the user and obtains, with a sensor, physiological data (e.g., gaze characteristics) and motion data (e.g., controller moving the avatar, head movements, etc.) associated with a response of the user. Based on the obtained physiological data, the techniques described herein can determine a user's vestibular cues during the viewing of a 3D environment (e.g., an extended reality (XR) environment) by tracking the user's gaze characteristic(s) and other interactions (e.g., user movements in the physical environment). Based on the vestibular cues, the techniques can detect interactions with the virtual content and provide a different set of views to improve a user's experience while viewing the 3D environment. For example, detecting that the user is in a situation in which the user would benefit from virtual content assistance (e.g., a particular application). Example contexts that may trigger virtual content (e.g., a particular application) include (a) user activity at a time of day (e.g., a first look at a mirror in the morning, display calendar app and a news app), (b) a user performing an activity (e.g., putting on makeup triggers an enhancement or beauty app, or trying on new clothes triggers a clothing app), (c) a user acting in a certain way or a verbal command (e.g., dancing to record a social media video), and/or (d) a user being proximate to a particular location, object, or person (e.g., if the detected mirror is in a gym, display a gym app to track progress, etc.). The virtual content that appears positioned on (or based on) the mirror may be positioned on or based on a 3D position of the reflection (e.g., mirror). The virtual content may also be interactive such that a user can change the size of the app, move the app, select on or more selectable icons on the app, close the app, and the like.

In general, one innovative aspect of the subject matter described in this specification can be embodied in methods, at an electronic device having a processor and one or more sensors, that include the actions of obtaining sensor data from the one or more sensors of the electronic device in a physical environment that includes one or more objects, detecting a reflected image amongst the one or more objects based on the sensor data, and in accordance with detecting the reflected image, determining a context associated with a use of the electronic device in the physical environment based on the sensor data, and presenting virtual content based on the context, wherein the virtual content is positioned at a three-dimensional (3D) location based on a 3D position of the reflected image.

These and other embodiments can each optionally include one or more of the following features.

In some aspects, detecting the reflected image is based on tracking facial features of a user of the electronic device. In some aspects, detecting the reflected image is based on facial recognition of a user of the electronic device.

In some aspects, the sensor data comprises images of a head of a user of the electronic device, and wherein detecting the reflected image is based on determining that the head of the user as seen in the images is rotating about a vertical axis by an amount that is double an amount of rotation of the electronic device, or the head of the user as seen in the images is not rotating about a forward axis.

In some aspects, the 3D position of the reflected image is determined based on depth data from the sensor data and the 3D location of the virtual content is based on the depth data associated with the 3D position of the reflected image.

In some aspects, detecting the reflected image is based on an object detection technique using machine learning.

In some aspects, the context comprises a time of day, and presenting the virtual content is based on the time of day. In some aspects, the time of day is the morning and the virtual content comprises a calendar application or a news application.

In some aspects, the context comprises movements of a user of the electronic device with respect to the reflected image, and presenting the virtual content is based on the movements of the user. In some aspects, the context comprises a user interaction with the reflected image, and presenting the virtual content is based on the user interaction with the reflected image.

In some aspects, determining the context comprises determining use of the electronic device in a new location. In some aspects, determining the context comprises determining use of the electronic device during a type of activity. In some aspects, determining the context comprises determining that the electronic device is within a proximity threshold distance of a location, an object, another electronic device, or a person.

In some aspects, a depth position of the 3D location of the virtual content is the same as a depth of a reflected object detected in the reflected image.

In some aspects, the physical environment includes one or more objects, and detecting the reflected image comprises detecting a mirror amongst the one or more objects based on the sensor data.

In some aspects, the electronic device is a head-mounted device (HMD).

In accordance with some implementations, a non-transitory computer readable storage medium has stored therein instructions that are computer-executable to perform or cause performance of any of the methods described herein. In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 illustrates a device presenting a visual environment and obtaining physiological data from a user in a real-world physical environment that includes a mirror according to some implementations.

FIG. 2 illustrates an exemplary view of the electronic device of FIG. 1 in accordance with some implementations.

FIG. 3 illustrates an exemplary view of the electronic device of FIG. 1 in accordance with some implementations

FIG. 4 is a flowchart representation of presenting virtual content based on detecting a reflection and determining the context associated with a use of an electronic device in the physical environment in accordance with some implementations.

FIG. 5 illustrates device components of an exemplary device according to some implementations.

FIG. 6 illustrates an example head-mounted device (HMD) in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects or variants do not include all of the specific details described herein. Moreover, well-known systems, methods, components, devices and circuits have not been described in exhaustive detail so as not to obscure more pertinent aspects of the example implementations described herein.

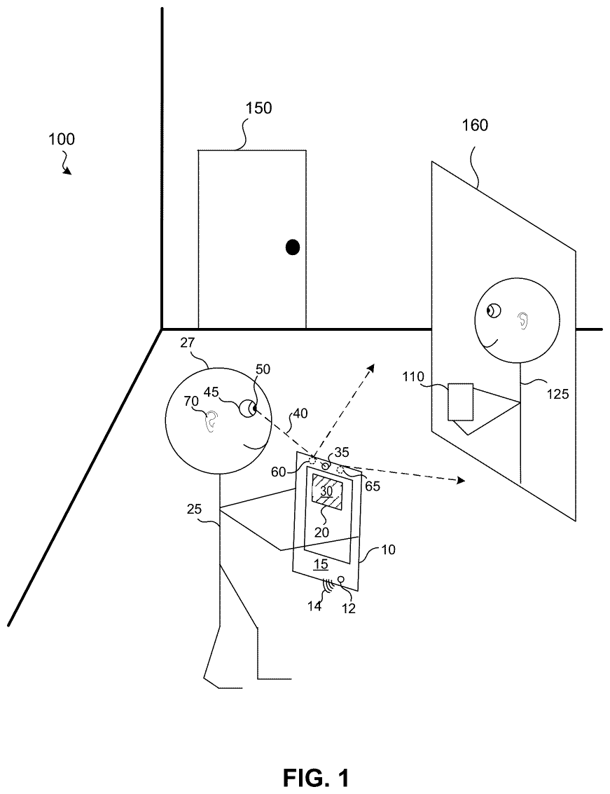

FIG. 1 illustrates a real-world physical environment 100 including a device 10 with a display 15. In some implementations, the device 10 presents content 20 to a user 25, and a visual characteristic 30 that is associated with content 20. In some examples, content 20 may be a button, a user interface icon, a text box, a graphic, etc. In some implementations, the visual characteristic 30 associated with content 20 includes visual characteristics, such as hue, saturation, size, shape, spatial frequency, motion, highlighting, etc. For example, content 20 may be displayed with a visual characteristic 30 of green highlighting covering or surrounding content 20.

Additionally, the physical environment 100 includes a door 150 and a mirror or other reflective surface 160. The mirror 160 reflects a portion of the physical environment 100. For example, as illustrated, mirror 160 is showing a reflection 125 of user 25 and reflection 110 of device 10 as the user 25 is gazing at his or her own reflection 125. The remaining environment of physical environment 100 that is behind the user 25 (e.g., the background) is not illustrated in FIG. 1, or the other figures, for illustrative purposes so that it is easier to focus on the subject matter discussed herein (e.g., a reflected portion of the user 25 and device 10).

In some implementations, content 20 may represent a visual 3D environment (e.g., an extended reality (XR) environment), and the visual characteristic 30 of the 3D environment may continuously change. Head pose measurements may be obtained by an inertial measurement unit (IMU) or other tracking systems. In one example, a user can perceive a real-world physical environment while holding, wearing, or being proximate to an electronic device that includes one or more sensors that obtains physiological data to assess an eye characteristic that is indicative of the user's gaze characteristics, and motion data of a user.

In some implementations, the visual characteristic 30 is a feedback mechanism for the user that is specific to the views of the 3D environment (e.g., a visual or audio cue presented during the viewing). In some implementations, the view of the 3D environment (e.g., content 20) can occupy the entire display area of display 15. For example, content 20 may include a sequence of images as the visual characteristic 30 and/or audio cues presented to the user (e.g., 360-degree video on a head mounted device (HMD)).

The device 10 obtains physiological data (e.g., pupillary data) from the user 25 via a sensor 35 (e.g., one or more camera's facing the user to capture light intensity data and/or depth data of a user's facial features and/or eye gaze). For example, the device 10 obtains eye gaze characteristic data 40. While this example and other examples discussed herein illustrates a single device 10 in a real-world physical environment 100, the techniques disclosed herein are applicable to multiple devices as well as to other real-world physical environments. For example, the functions of device 10 may be performed by multiple devices.

In some implementations, as illustrated in FIG. 1, the device 10 is a handheld electronic device (e.g., a smartphone or a tablet). In some implementations, the device 10 is a wearable HMD. In some implementations the device 10 is a laptop computer or a desktop computer. In some implementations, the device 10 has a touchpad and, in some implementations, the device 10 has a touch-sensitive display (also known as a “touch screen” or “touch screen display”).

In some implementations, the device 10 includes sensors 60, 65 for acquiring image data of the physical environment. The image data can include light intensity image data and/or depth data. For example, sensor 60 may be a video camera for capturing RGB data, and sensor 65 may be a depth sensor (e.g., a structured light, a time-of-flight, or the like) for capturing depth data.

In some implementations, the device 10 includes an eye tracking system for detecting eye position and eye movements. For example, an eye tracking system may include one or more infrared (IR) light-emitting diodes (LEDs), an eye tracking camera (e.g., near-IR (NIR) camera), and an illumination source (e.g., an NIR light source) that emits light (e.g., NIR light) towards the eyes of the user 25. Moreover, the illumination source of the device 10 may emit NIR light to illuminate the eyes of the user 25 and the NIR camera may capture images of the eyes of the user 25. In some implementations, images captured by the eye tracking system may be analyzed to detect position and movements of the eyes of the user 25, or to detect other information about the eyes such as pupil dilation or pupil diameter. Moreover, the point of gaze estimated from the eye tracking images may enable gaze-based interaction with content shown on the display of the device 10.

In some implementations, the device 10 has a graphical user interface (GUI), one or more processors, memory and one or more modules, programs or sets of instructions stored in the memory for performing multiple functions. In some implementations, the user 25 interacts with the GUI through finger contacts and gestures on the touch-sensitive surface. In some implementations, the functions include image editing, drawing, presenting, word processing, website creating, disk authoring, spreadsheet making, game playing, telephoning, video conferencing, e-mailing, instant messaging, workout support, digital photographing, digital videoing, web browsing, digital music playing, and/or digital video playing. Executable instructions for performing these functions may be included in a computer readable storage medium or other computer program product configured for execution by one or more processors.

In some implementations, the device 10 employs various physiological sensor, detection, or measurement systems. In an exemplary implementation, detected physiological data includes head pose measurements determined by an IMU or other tracking system. In some implementations, detected physiological data may include, but is not limited to, electroencephalography (EEG), electrocardiography (ECG), electromyography (EMG), functional near infrared spectroscopy signal (fNIRS), blood pressure, skin conductance, or pupillary response. Moreover, the device 10 may concurrently detect multiple forms of physiological data in order to benefit from synchronous acquisition of physiological data. Moreover, in some implementations, the physiological data represents involuntary data, e.g., responses that are not under conscious control. For example, a pupillary response may represent an involuntary movement.

In some implementations, a machine learning model (e.g., a trained neural network) is applied to identify patterns in physiological data, including identification of physiological responses to viewing the 3D environment (e.g., content 20 of FIG. 1). Moreover, the machine learning model may be used to match the patterns with learned patterns corresponding to indications of interest or intent of the user 25 interactions. In some implementations, the techniques described herein may learn patterns specific to the particular user 25. For example, the techniques may learn from determining that a peak pattern represents an indication of interest or intent of the user 25 in response to a particular visual characteristic 30 when viewing the 3D environment, and use this information to subsequently identify a similar peak pattern as another indication of interest or intent of the user 25. Such learning can take into account the user's relative interactions with multiple visual characteristics 30, in order to further adjust the visual characteristic 30 and enhance the user's physiological response to the 3D environment.

In some implementations, the location and features of the head 27 of the user 25 (e.g., an edge of the eye, a nose or a nostril) are extracted by the device 10 and used in finding coarse location coordinates of the eyes 45 of the user 25, thus simplifying the determination of precise eye 45 features (e.g., position, gaze direction, etc.) and making the gaze characteristic(s) measurement more reliable and robust. Furthermore, the device 10 may readily combine the 3D location of parts of the head 27 with gaze angle information obtained via eye part image analysis in order to identify a given on-screen object at which the user 25 is looking at any given time. In some implementations, the use of 3D mapping in conjunction with gaze tracking allows the user 25 to move his or her head 27 and eyes 45 freely while reducing or eliminating the need to actively track the head 27 using sensors or emitters on the head 27.

By tracking the eyes 45, some implementations reduce the need to re-calibrate the user 25 after the user 25 moves his or her head 27. In some implementations, the device 10 uses depth information to track the pupil's 50 movement, thereby enabling a reliable present pupil diameter to be calculated based on a single calibration of user 25. Utilizing techniques such as pupil-center-corneal reflection (PCCR), pupil tracking, and pupil shape, the device 10 may calculate the pupil diameter, as well as a gaze angle of the eye 45 from a fixed point of the head 27, and use the location information of the head 27 in order to re-calculate the gaze angle and other gaze characteristic(s) measurements. In addition to reduced recalibrations, further benefits of tracking the head 27 may include reducing the number of light projecting sources and reducing the number of cameras used to track the eye 45.

In some implementations, a pupillary response may be in response to an auditory stimulus that one or both ears 70 of the user 25 detect. For example, device 10 may include a speaker 12 that projects sound via sound waves 14. The device 10 may include other audio sources such as a headphone jack for headphones, a wireless connection to an external speaker, and the like.

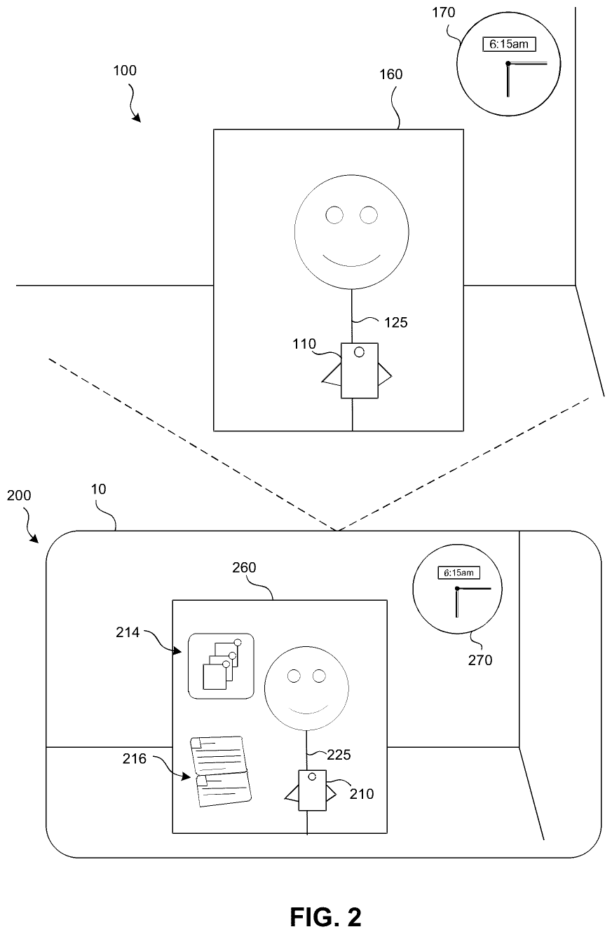

FIG. 2 illustrates an exemplary view 200 of the physical environment 100 provided by electronic device 10. The view 200 may be a live camera view of the physical environment 100, a view of the physical environment 100 through a see-through display, or a view generated based on a 3D model corresponding to the physical environment 100. The view 200 includes depictions of aspects of a physical environment 100 such as a representation 260 of mirror 160 and representation 270 of clock 170 (not shown in FIG. 1 based on the viewing angle). Within the view of representation 260 of mirror 160 is the representation 225 of the reflection 125 of user 25 and representation 210 of the reflection 110 of the device 10.

Additionally, the view of representation 260 (e.g., mirror 160) includes virtual content 214 and virtual content 216 that are presented based on detecting a reflection or detecting a mirror 160 (e.g., detecting a reflection from a surface of an object), and determining a context associated with a use of the electronic device 10 in the physical environment 100 based on sensor data. The virtual content 214 and virtual content 216 may be selected for presentation based on the context and positioned at a three-dimensional (3D) location based on a 3D position of the mirror 160 (e.g., a reflective surface of an object). For example, the determined context of the current environment of FIG. 2 may be that the user 25 is looking at himself or herself in the mirror 160 early in the morning (e.g., clock 170 shows a time of 6:15 am). Thus, the context includes a time of day, and presenting the virtual content 214, 216 (e.g., virtual applications) is based on the time of day. In other words, detecting that the user 25 is in a situation in which the user would benefit from a particular user interface, such as in the morning, device 10 may provide a calendar application (virtual content 216), a news application (virtual content 214), and the like. Additionally, the virtual content 214, 216 may be presented such that it appears to be located on the surface of the representation 260 of mirror 160 in view 200. In other examples, the virtual content 214, 216 may be presented at a depth corresponding to the depth of the reflection 125 of user 25 (e.g., twice the distance between user 25 and mirror 160). Positioning virtual content 214, 216 at this depth may advantageously prevent user 25 from having to change the focal plane of their eyes when looking from their reflection 125 to virtual content 214, 216, or vice versa. In yet other examples, the virtual content 214, 216 may be presented such that it appears to be located at other locations in view 200.

In some implementations, virtual content 214, 216 may be provided automatically (e.g., in response to the determined context based on time of day). Additionally, or alternatively, virtual content 214, 216 may be provided by the user's interaction with the device 10 (e.g., selecting an app) or by a verbal request (e.g., “please show my calendar app on the mirror”). The virtual content 214, 216 is for an exemplary illustration. Additionally, or alternatively, the virtual content 214, 216 may include spatialized audio and/or video. For example, virtual content 214, instead of showing a news feed application, may include a live news channel displayed on the mirror 160 (e.g., a news television channel being displayed virtually within the representation 260 of mirror 160). In an exemplary implementation, the virtual content includes an audio cue played to be heard from a 3D position on the representation 260 of the mirror 160 using spatial audio, wherein the 3D position is determined based on the context, the position of the reflection (e.g., mirror 160), or both. For example, for a particular use case where an application desires to direct the user's 25 attention to a particular location (and a particular depth), a spatialized audio cue can be presented to the user 25 in order to cause him or her to look at a reflection of an object that may be off in the distance (but within the view of the mirror 160).

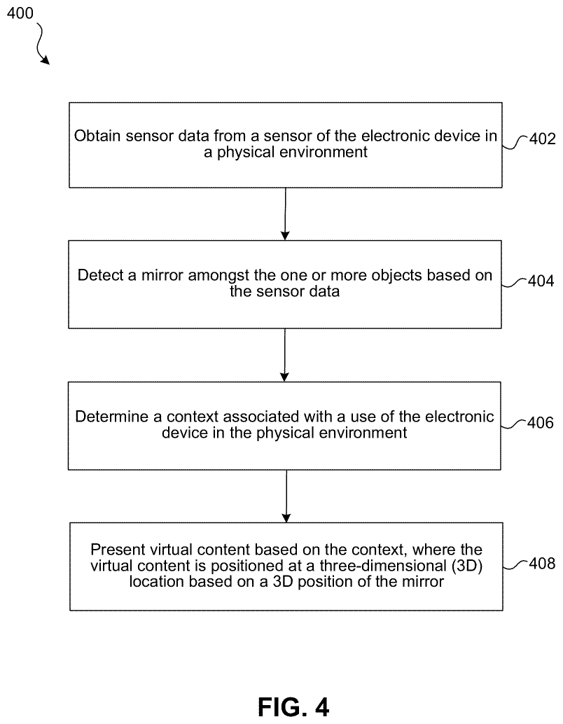

The electronic device 10 determines whether an object in the physical environment 100 is a reflective object, such as mirror 160, by using one or more mirror detection techniques that are further discussed below for FIG. 4. For example, mirror detection techniques may include using facial detection regions over time to compare the location and relative angle of the facial boundaries when wearing an HMD. A mirror can also be detected based on object recognition using machine learning techniques. In cases where the user is looking at themselves in a mirror, bounding rectangles can be contained in a specific region and will not show any rotation, even as the camera/device moves. Once it has been detected that a user is looking in a mirror, the boundaries can be detected with shape analysis and the loss of the tracked facial recognition in the region.

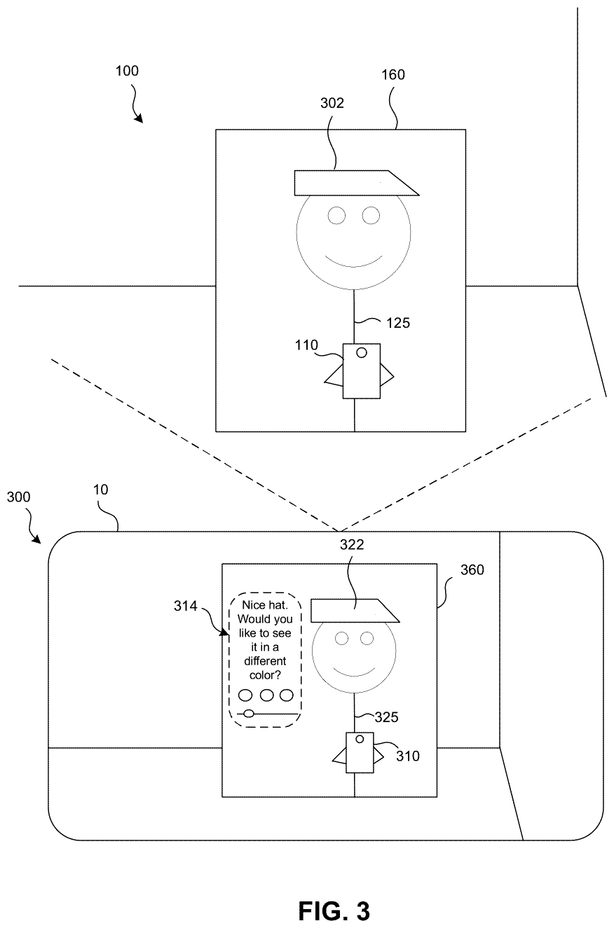

FIG. 3 illustrates an exemplary view 300 of the physical environment 100 provided by electronic device 10. The view 300 may be a live camera view of the physical environment 100, a view of the physical environment 100 through a see-through display, or a view generated based on a 3D model corresponding to the physical environment 100. The view 300 includes depictions of aspects of a physical environment 100 such as a representation 360 of mirror 160.

Within the view of representation 360 of mirror 160 is the representation 325 of the reflection 125 of user 25, representation 310 of the reflection 110 of the device 10, and representation 322 of the reflection 302 of an article of clothing (e.g., a hat). For example, after the use case described in FIG. 2, the user 25 is now trying on a new article of clothing to initiate a clothing app. Thus, the view of representation 360 (e.g., mirror 160) includes virtual content 314 that is presented based on detecting the mirror (or a reflective object), determining a context associated with a use of the electronic device in the physical environment based on sensor data, and presenting virtual content 314 based on the context, where the virtual content is positioned at a 3D location based on a 3D position of the reflection (e.g., mirror 160). For example, the determined context of the current environment of FIG. 3 is that the user is looking at himself or herself in the mirror trying on new clothes. In this case, the user put on a new hat and he or she wants to see how they look in the mirror. Thus, the context includes recognizing a new article of clothing. In other words, device 10 may detect that the user 25 is in a situation in which the user would benefit from a particular user interface, such as a clothing application (virtual content 314) that can allow the user to interact with the look of the clothing, or a similar application, and may present that interface (or other virtual content) to the user 25. For example, virtual content 314 includes interactive features that may allow a user to virtually change the appearance (e.g., color) of the representation 322 of the hat within the view 300.

In some implementations, the virtual content of FIGS. 2 and 3 (e.g., virtual content 214, 216, and 314) can be modified over time based on proximity of the electronic device to an anchored location (e.g., mirror 160). For example, as the user 25 gets closer, the spatialized audio notifications may indicate the closer proximity. Additionally, or alternatively, for a visual icon, the virtual content may increase in size or start flashing if the user starts to walk in a different direction away from the mirror 160. Additionally, the virtual content may include a text widget application that tells the user a location of an object displayed within the reflections of the mirror (or any reflective surface of an object).

In some implementations, a visual transition effect (e.g., fading, blurring, etc.) may be applied to the virtual content to provide the user with a more enjoyable XR experience. For example, as a user turns away from virtual content by more than a threshold amount (e.g., outside of an activation zone), the visual transition effect may be applied to the virtual content. Defining the activation zone based on an anchored content object encourages a user to stay relatively stationary and provides a target object to focus on. As a user moves, the visual transition effect applied to the virtual content may indicate to the user that the virtual content is going to deactivate (e.g., fades away). Thus, the user can dismiss the virtual content by turning away from the virtual content. In some implementations, transitioning away or fading away the virtual content may be based on a rate of turning their head or electronic device 10 exceeding a threshold or an amount of turning their head or electronic device 10 exceeding a threshold, such that the virtual content will remain in the 3D location where it was just before the user turned their head or electronic device 10.

The views 200 and 300 show the virtual content as being in a first, world-locked presentation mode such that it appears to remain at its position within environment 100 despite translational and/or rotational movement of the electronic device 10 (e.g., window applications anchored to the left of the reflection 225, 325 of the user 25). The view of the virtual content may remain world-locked until the user satisfies some condition and may transition to a different presentation mode, such as a head/display-locked presentation mode in which the virtual content remains displayed at the same location on the display 15 or relative to electronic device 10 as translational and/or rotational movement is applied to electronic device 10. For example, the window application anchored to the mirror 160 may be transitioned to a widget anchored to the top left corner of display 15 that the user can later active to see the application window. Selectively anchoring virtual content to a position on the display rather than a location in the environment when not in use may save power by requiring localization of content only when necessary. In certain implementations, better legibility of content (e.g., text messages within the virtual content) may also be achieved by positioning the virtual content at a fixed distance from the electronic device 10 or user's viewpoint. For example, holding a book at a particular distance can make it easier to read and understand. Similarly, positioning virtual content at a desirable distance can also make it easier to read and understand.

In some implementations, the system can detect the user's interaction with virtual content (e.g., reaching out to “touch” the virtual content) and may generate and display an application window. For example, a user in FIG. 3, may provide a motion of reaching out to interact with the reflection of the hat (e.g., representation 322 of the hat within the view 300), and the system may then display a new application window (e.g., virtual content 314. In some implementations, the system can detect that the user has temporarily moved his or her viewing direction to another location outside of an activation zone (e.g., an activation zone that contains a view of the virtual content application window). For example, the user may look away from an initial activation zone in response to being briefly distracted by some event in the physical environment (e.g., another person in the room). The system, based on the user “looking away” from the initial activation zone, may start to fade away and/or shrink the virtual content. However, once the user has returned to a viewpoint that is similar or identical to the original view when the virtual content and an associated application window was initially active (e.g., within an activation zone), the system can return to displaying the virtual content and an associated application window as initially intended when the user activated the application by interacting with the virtual content, before the user was briefly distracted.

In some implementations, the system can locate a mirror based on a notification or a request from an application on the device 110 or from another device. For example, if the user 125 receives a 3D model of a clothing article to view from another user (e.g., a friend provides a 3D model of a hat for the user 125 to virtually try on), the system can automatically attempt to locate a mirror (or a reflection on a surface of an object). Additionally, or alternatively, if the user 125 is in communication with another user via another device (e.g., a communication session such as a video chat room), and the other user sends a notification to find a mirror and try on a 3D model of a hat, the system can also automatically attempt to locate a mirror if the user 125 accepts the notification/request to try on the 3D model of the hat.

FIG. 4 is a flowchart illustrating an exemplary method 400. In some implementations, a device such as device 10 (FIG. 1) performs the techniques of method 400 of presenting virtual content (e.g., an application) based on detecting a reflection or other reflective surface and determining the context associated with a use of an electronic device in a physical environment. In some implementations, the techniques of method 400 are performed on a mobile device, desktop, laptop, HMD, or server device. In some implementations, the method 400 is performed on processing logic, including hardware, firmware, software, or a combination thereof. In some implementations, the method 400 is performed on a processor executing code stored in a non-transitory computer-readable medium (e.g., a memory). Examples of method 400 are illustrated with reference to FIGS. 2-3.

At block 402, the method 400 obtains sensor data (e.g., image, sound, motion, etc.) from the sensor of the electronic device in a physical environment that includes one or more objects. For example, the electronic device may capture one or more images of the user's current room, depth data, and the like. In some implementations, the sensor data includes depth data and light intensity image data obtained during an image capture process.

At block 404, the method 400 detects a reflection based on the sensor data. For example, detecting a mirror or other reflective surface amongst one or more objects in the physical environment. In some examples, detecting the reflection may include using facial detection regions over time, where a reflection can be detected by comparing the location and relative angle of the facial boundaries when wearing an HMD. Once it has been detected that a user is looking at a reflection, then the method 400 may determine whether the reflection is a mirror and detect the boundaries of the mirror based on shape analysis, edge detection, and/or the loss of the tracked facial recognition in the region.

In some implementations, detecting the reflection is based on a movement and attitude of the visually-sensed face of a user (or other object) that is correlated with the movement/attitude of the sensing device. For example, in cases where the user is looking at themselves in a reflection, bounding rectangles can be contained in a specific region and may not show rotation, even as the camera/device moves. For example, since the image sensors may be worn on the user's head, the user's face in the captured images will not show a change in orientation about a forward-facing axis despite rotation about the same axis by the electronic device. The detected rotation of the sensing device about an axis may include the vertical axis, the horizontal axis, or both. Detecting the reflection based on either axis may further include the relation of orientation as determined by visually-sensed face of a user (or other object) that is correlated with the movement/attitude of the sensing device.

In some implementations, detecting the reflection is based on tracking facial features of a user of the electronic device. In some implementations, detecting the reflection is based on facial recognition of a user of the electronic device. In some implementations, the sensor data includes images of a head of a user of the electronic device and detecting the reflection is based on determining that the head of the user is rotating in a yaw direction (e.g., about a vertical axis). For example, a mirror may be detected in response to seeing a face that does not rotate about a forward-facing axis and that rotates about a vertical axis by an amount that is double than what is determined for device 10 by onboard sensors (e.g., from a gyroscope).

In some implementations, if the reflective surface is not completely reflective (e.g., a window), additional visual techniques can be utilized to help detect the reflection. For example, a machine learning model can be trained to recognize the characteristic double-images of a reflection superimposed on the real world.

In some implementations, detecting the reflection is based on detecting a mirror amongst one or more objects in the physical environment. For detecting the physical object of the mirror, in addition to edge finding and other purely visual or static techniques, the system may also utilize time-dependent techniques such as a visual inertial odometry (VIO) system, or the like. For example, a mirror may present similarly as a window into another space, and the edges of that window can be detected using relative parallax between the surface the mirror that it lies on and the reflective image within it. Additionally, or alternatively, in some implementations, detecting the physical object of the mirror can be detected using depth sensors (e.g., using an active time-of-flight sensor) to decipher the relative parallax between the surface the mirror that it lies on and the reflective image within it.

In some implementations, detecting the reflection may be based on non-geometric correlations. For example, a reflection of the electronic device may be detected as a sensed device, and the sensed device may be determined to be visually identical, or nearly identical, to the sensing device. For example, a tablet detecting an HMD would not infer a mirror. Additionally, or alternatively, a sensed face of a user may be determined to be visually similar to the face of the person holding the electronic device (e.g., wearing the HMD). Additionally, or alternatively, in some implementations, a likelihood of detecting a mirror may be determined by other sensing parameters of the general environment, such as plane detection techniques. For example, mirrors are likely to lie on or near and parallel to larger planes, such as walls.

In some implementations, detecting the reflection, such as a mirror, is based on an object detection technique using machine learning (e.g., a neural network, decision tree, support vector machine, Bayesian network, or the like).

At block 406, in accordance with detecting the reflection, the method 400 determines a context associated with a use of the electronic device in the physical environment based on the sensor data. For example, determining the context may include detecting that the user is in a situation in which the user would benefit from presenting virtual content (e.g., a particular app), such as a time of day, trying on new clothes, putting on makeup, etc.

Various ways of detecting context of a physical environment may be used by method 400. In some implementations, detecting the context includes determining use of the electronic device in a new location (e.g., using a mirror in a hotel room the user has not been to previously). In some implementations, detecting the context includes determining use of the electronic device during a type of activity (e.g., exercising, putting on makeup, trying on new clothes, etc.). In some implementations, detecting the context includes determining that the electronic device is within a proximity threshold distance of a location, an object, another electronic device, or a person.

In some implementations, the method 400 further includes tracking a pose of the electronic device relative to the physical environment, and detecting, based on the pose of the electronic device, that a view of a display of the electronic device is oriented towards the virtual content. For example, position sensors may be utilized to acquire positioning information of the device (e.g., device 10). For the positioning information, some implementations include a VIO system to determine equivalent odometry information using sequential camera images (e.g., light intensity images such as RGB data) to estimate the distance traveled. Alternatively, some implementations of the present disclosure may include a SLAM system (e.g., position sensors). The SLAM system may include a multidimensional (e.g., 3D) laser scanning and range measuring system that is GPS-independent and that provides real-time simultaneous location and mapping. The SLAM system may generate and manage data for a very accurate point cloud that results from reflections of laser scanning from objects in an environment. Movements of any of the points in the point cloud are accurately tracked over time, so that the SLAM system can maintain precise understanding of its location and orientation as it travels through an environment, using the points in the point cloud as reference points for the location. The SLAM system may further be a visual SLAM system that relies on light intensity image data to estimate the position and orientation of the camera and/or the device. For example, for 3D reconstruction algorithms, knowing there is a mirror will inform the SLAM system to be updated accordingly.

In some implementations, obtaining sensor data (e.g., image, sound, motion, etc.) from the sensor of the electronic device in a physical environment includes tracking a gaze direction, and detecting that the gaze direction corresponds to the detected mirror of the physical environment. In some implementations, tracking the gaze of a user may include tracking which pixel the user's gaze is currently focused upon. For example, obtaining physiological data (e.g., eye gaze characteristic data 40) associated with a gaze of a user may involve obtaining images of the eye or electrooculography signal (EOG) data from which gaze direction and/or movement can be determined. In some implementations, the 3D environment may be an XR environment provided while a user wears a device such as an HMD. Additionally, the XR environment may be presented to the user where virtual reality images maybe overlaid onto the live view (e.g., augmented reality (AR)) of the physical environment. In some implementations, tracking the gaze of the user relative to the display includes tracking a pixel the user's gaze is currently focused upon.

At block 408, the method 400 presents virtual content based on the context, where the virtual content is positioned at a 3D location based on a 3D position of the reflection (e.g., mirror). For example, in response to detecting that the user is in a situation in which the user would benefit from a particular UI, such as in the morning, virtual content, such as a calendar app, news, etc. may be provided. In other examples, a clothing app may be presented in response to determining that the user is looking at himself/herself or turning in a particular manner while wearing new clothes/hat. In other examples, if the user is acting a certain way (e.g., making particular hand gestures) or providing a verbal command, a social media video recording app may be presented. In other examples, if the user is determined to be in the gym, a fitness app may be displayed to track progress, provide exercise techniques, etc. In other examples, if the user is determined to be putting on makeup, etc., a zoomed in enhancement view of the face of the user may be provided. Additionally, the virtual content may be positioned on or based on a 3D position of the reflection (e.g., a position of the object with a reflective surface such as a mirror).

In some implementations, the 3D position of the reflection is determined based on depth data from the sensor data and the 3D location of the virtual content is based on the depth data associated with the 3D position of the reflection. For example, the virtual content may be placed at the same depth as the mirror. In some examples, the depth can be detected by taking distance of the user's reflection as determined by a computer-vision technique and dividing by two. Additionally, or alternatively, a 3D location could also be at a virtual depth of the user in the mirror (e.g., depth determined by computer-vision).

In some implementations, a depth position of the 3D location of the virtual content is the same as a depth of a reflected object detected in the mirror. For example, the virtual content (e.g., a clothing application such as virtual content 314) appears to be at the same depth as the user's reflection 325 to make the content being displayed (e.g., the text) easier to see/read, etc., for a better visual experience for the user. In particular, positioning the virtual content at the same depth as the user's reflection 325 may advantageously prevent the user from having to change the focal plane of their eyes when looking from their reflection to the virtual content, or vice versa.

In some implementations, the context includes a time of day, and presenting the virtual content is based on the time of day. For example, as illustrated in FIG. 2, the context includes a situation in which the user would benefit from a particular UI, such as in the morning, and virtual content, such as a calendar app, news app, and the like, may be presented such that it appears on the surface of the mirror as an application window.

In some implementations, the context includes movements of a user of the electronic device with respect to the mirror, and presenting the virtual content is based on the movements of the user. For example, as illustrated in FIG. 3, if the user is looking at himself or herself, or turning a particular manner for new clothes/hat, the virtual content may include a clothing app.

In some implementations, the context includes a user interaction with the mirror, and presenting the virtual content is based on the user interaction with the mirror. For example, the context may include touching the mirror at a location of the virtual content, swiping action on the mirror to close a window/application, a verbal command, etc., to activate and/or interact with a particular app.

In some implementations, the virtual content (e.g., virtual content 214, 216, and 314 of FIGS. 2 and 3, respectively) can be modified over time based on proximity of the electronic device to an anchored location (e.g., mirror 160). For example, as the user 25 gets closer, spatialized audio notifications may indicate the closer proximity. Additionally, or alternatively, for a visual icon, the virtual content may increase in size or start flashing if the user starts to walk in a different direction away from the mirror 160. Additionally, the virtual content may include a text widget application that tells the user a location of an object displayed within the reflections of the mirror (or any reflective surface of an object).

In some examples, method 400 may further include capturing an image of the user in response to detecting the reflection. For example, an image may be captured once a day to allow the user to track their appearance over time. In other examples, activity data of the user may be recorded in response to detecting the reflection. For example, if it is determined that the user is at the gym or performing a workout in front of a mirror, the electronic device 10 may record a duration of the workout or number of calories burned.

In some examples, method 400 may further include a self-presentation mode for presenting virtual content for a user to use a mirror to see what his or her self-presentation may look like to others in an XR environment (e.g., during a communication session). For example, if a user wants to reveal information publicly to other XR users (e.g., a “nametag” or other identifying information), then after detecting a reflective surface, the user can initiate the self-presentation mode to view the self-identifying virtual content.

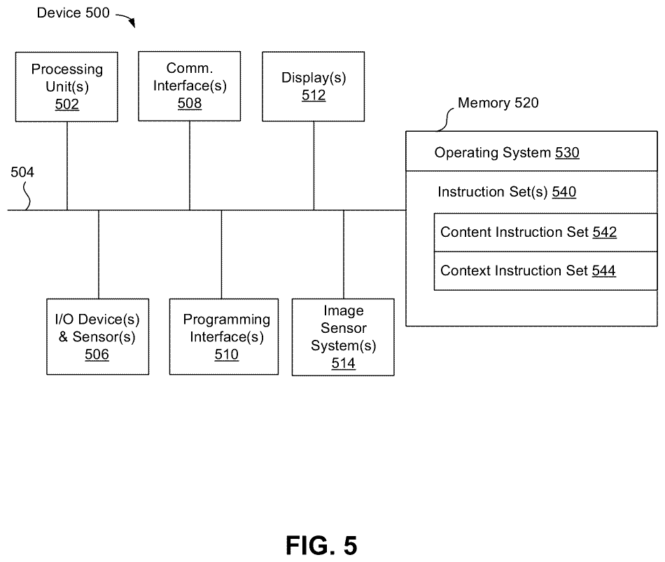

FIG. 5 is a block diagram of an example device 500. Device 500 illustrates an exemplary device configuration for device 10. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 10 includes one or more processing units 502 (e.g., microprocessors, ASICs, FPGAs, GPUs, CPUs, processing cores, and/or the like), one or more input/output (I/O) devices and sensors 506, one or more communication interfaces 508 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, SPI, I2C, and/or the like type interface), one or more programming (e.g., I/O) interfaces 510, one or more displays 512, one or more interior and/or exterior facing image sensor systems 514, a memory 520, and one or more communication buses 504 for interconnecting these and various other components.

In some implementations, the one or more communication buses 504 include circuitry that interconnects and controls communications between system components. In some implementations, the one or more I/O devices and sensors 506 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more displays 512 are configured to present a view of a physical environment or a graphical environment to the user. In some implementations, the one or more displays 512 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), and/or the like display types. In some implementations, the one or more displays 512 correspond to diffractive, reflective, polarized, holographic, etc. waveguide displays. In one example, the device 10 includes a single display. In another example, the device 10 includes a display for each eye of the user.

In some implementations, the one or more image sensor systems 514 are configured to obtain image data that corresponds to at least a portion of the physical environment 100. For example, the one or more image sensor systems 514 include one or more RGB cameras (e.g., with a complimentary metal-oxide-semiconductor (CMOS) image sensor or a charge-coupled device (CCD) image sensor), monochrome cameras, IR cameras, depth cameras, event-based cameras, and/or the like. In various implementations, the one or more image sensor systems 514 further include illumination sources that emit light, such as a flash. In various implementations, the one or more image sensor systems 514 further include an on-camera image signal processor (ISP) configured to execute a plurality of processing operations on the image data.

The memory 520 includes high-speed random-access memory, such as DRAM, SRAM, DDR RAM, or other random-access solid-state memory devices. In some implementations, the memory 520 includes non-volatile memory, such as one or more magnetic disk storage devices, optical disk storage devices, flash memory devices, or other non-volatile solid-state storage devices. The memory 520 optionally includes one or more storage devices remotely located from the one or more processing units 502. The memory 520 includes a non-transitory computer readable storage medium.

In some implementations, the memory 520 or the non-transitory computer readable storage medium of the memory 520 stores an optional operating system 530 and one or more instruction set(s) 540. The operating system 530 includes procedures for handling various basic system services and for performing hardware dependent tasks. In some implementations, the instruction set(s) 540 include executable software defined by binary information stored in the form of electrical charge. In some implementations, the instruction set(s) 540 are software that is executable by the one or more processing units 502 to carry out one or more of the techniques described herein.

The instruction set(s) 540 include a content instruction set 542 and a context instruction set 544. The instruction set(s) 540 may be embodied a single software executable or multiple software executables.

In some implementations, the content instruction set 542 is executable by the processing unit(s) 502 to provide and/or track content for display on a device. The content instruction set 542 may be configured to monitor and track the content over time (e.g., while viewing an XR environment), and generate and display virtual content (e.g., an application associated with the determined context). To these ends, in various implementations, the instruction includes instructions and/or logic therefor, and heuristics and metadata therefor.

In some implementations, the context instruction set 544 is executable by the processing unit(s) 502 to determine a context associated with a use of the electronic device (e.g., device 10) in the physical environment (e.g., physical environment 100) using one or more of the techniques discussed herein or as otherwise may be appropriate. To these ends, in various implementations, the instruction includes instructions and/or logic therefor, and heuristics and metadata therefor.

Although the instruction set(s) 540 are shown as residing on a single device, it should be understood that in other implementations, any combination of the elements may be located in separate computing devices. Moreover, FIG. 5 is intended more as functional description of the various features which are present in a particular implementation as opposed to a structural schematic of the implementations described herein. As recognized by those of ordinary skill in the art, items shown separately could be combined and some items could be separated. The actual number of instructions sets and how features are allocated among them may vary from one implementation to another and may depend in part on the particular combination of hardware, software, and/or firmware chosen for a particular implementation.

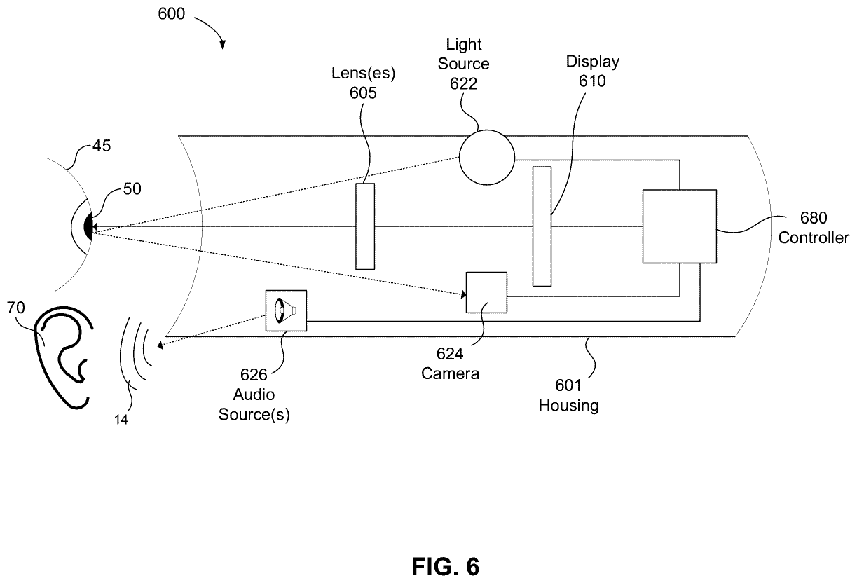

FIG. 6 illustrates a block diagram of an exemplary head-mounted device 600 in accordance with some implementations. The head-mounted device 600 includes a housing 601 (or enclosure) that houses various components of the head-mounted device 600. The housing 601 includes (or is coupled to) an eye pad (not shown) disposed at a proximal (to the user 25) end of the housing 601. In various implementations, the eye pad is a plastic or rubber piece that comfortably and snugly keeps the head-mounted device 600 in the proper position on the face of the user 25 (e.g., surrounding the eye 45 of the user 25).

The housing 601 houses a display 610 that displays an image, emitting light towards or onto the eye of a user 25. In various implementations, the display 610 emits the light through an eyepiece having one or more lenses 605 that refracts the light emitted by the display 610, making the display appear to the user 25 to be at a virtual distance farther than the actual distance from the eye to the display 610. For the user 25 to be able to focus on the display 610, in various implementations, the virtual distance is at least greater than a minimum focal distance of the eye (e.g., 7 cm). Further, in order to provide a better user experience, in various implementations, the virtual distance is greater than 1 meter.

The housing 601 also houses an eye/gaze tracking system including one or more light sources 622, camera 624, and a controller 680. The one or more light sources 622 emit light onto the eye of the user 25 that reflects as a light pattern (e.g., a circle of glints) that can be detected by the camera 624. Based on the light pattern, the controller 680 can determine an eye tracking characteristic of the user 25. For example, the controller 680 can determine a gaze direction and/or a blinking state (eyes open or eyes closed) of the user 25. As another example, the controller 680 can determine a pupil center, a pupil size, or a point of regard. Thus, in various implementations, the light is emitted by the one or more light sources 622, reflects off the eye 45 of the user 25, and is detected by the camera 624. In various implementations, the light from the eye 45 of the user 25 is reflected off a hot mirror or passed through an eyepiece before reaching the camera 624.

The housing 601 also houses an audio system that includes one or more audio source(s) 626 that the controller 680 can utilize for providing audio to the user ears 70 via sound waves 14 per the techniques described herein. For example, audio source(s) 626 can provide sound for both background sound and the auditory stimulus that can be presented spatially in a 3D coordinate system. The audio source(s) 626 can include a speaker, a connection to an external speaker system such as headphones, or an external speaker connected via a wireless connection.

The display 610 emits light in a first wavelength range and the one or more light sources 622 emit light in a second wavelength range. Similarly, the camera 624 detects light in the second wavelength range. In various implementations, the first wavelength range is a visible wavelength range (e.g., a wavelength range within the visible spectrum of approximately 400-700 nm) and the second wavelength range is a near-infrared wavelength range (e.g., a wavelength range within the near-infrared spectrum of approximately 700-1400 nm).

In various implementations, eye tracking (or, in particular, a determined gaze direction) is used to enable user interaction (e.g., the user 25 selects an option on the display 610 by looking at it), provide foveated rendering (e.g., present a higher resolution in an area of the display 610 the user 25 is looking at and a lower resolution elsewhere on the display 610), or correct distortions (e.g., for images to be provided on the display 610).

In various implementations, the one or more light sources 622 emit light towards the eye of the user 25 which reflects in the form of a plurality of glints.

In various implementations, the camera 624 is a frame/shutter-based camera that, at a particular point in time or multiple points in time at a frame rate, generates an image of the eye of the user 25. Each image includes a matrix of pixel values corresponding to pixels of the image which correspond to locations of a matrix of light sensors of the camera. In implementations, each image is used to measure or track pupil dilation by measuring a change of the pixel intensities associated with one or both of a user's pupils.

In various implementations, the camera 624 is an event camera including a plurality of light sensors (e.g., a matrix of light sensors) at a plurality of respective locations that, in response to a particular light sensor detecting a change in intensity of light, generates an event message indicating a particular location of the particular light sensor.

It will be appreciated that the implementations described above are cited by way of example, and that the present invention is not limited to what has been particularly shown and described hereinabove. Rather, the scope includes both combinations and sub combinations of the various features described hereinabove, as well as variations and modifications thereof which would occur to persons skilled in the art upon reading the foregoing description and which are not disclosed in the prior art.

As described above, one aspect of the present technology is the gathering and use of physiological data to improve a user's experience of an electronic device with respect to interacting with electronic content. The present disclosure contemplates that in some instances, this gathered data may include personal information data that uniquely identifies a specific person or can be used to identify interests, traits, or tendencies of a specific person. Such personal information data can include physiological data, demographic data, location-based data, telephone numbers, email addresses, home addresses, device characteristics of personal devices, or any other personal information.

The present disclosure recognizes that the use of such personal information data, in the present technology, can be used to the benefit of users. For example, the personal information data can be used to improve interaction and control capabilities of an electronic device. Accordingly, use of such personal information data enables calculated control of the electronic device. Further, other uses for personal information data that benefit the user are also contemplated by the present disclosure.

The described technology may gather and use information from various sources. This information may, in some instances, include personal information that identifies or may be used to locate or contact a specific individual. This personal information may include demographic data, location data, telephone numbers, email addresses, date of birth, social media account names, work or home addresses, data or records associated with a user's health or fitness level, or other personal or identifying information.

The collection, storage, transfer, disclosure, analysis, or other use of personal information should comply with well-established privacy policies or practices. Privacy policies and practices that are generally recognized as meeting or exceeding industry or governmental requirements should be implemented and used. Personal information should be collected for legitimate and reasonable uses and not shared or sold outside of those uses. The collection or sharing of information should occur after receipt of the user's informed consent.

It is contemplated that, in some instances, users may selectively prevent the use of, or access to, personal information. Hardware or software features may be provided to prevent or block access to personal information. Personal information should be handled to reduce the risk of unintentional or unauthorized access or use. Risk can be reduced by limiting the collection of data and deleting the data once it is no longer needed. When applicable, data de-identification may be used to protect a user's privacy.

Although the described technology may broadly include the use of personal information, it may be implemented without accessing such personal information. In other words, the present technology may not be rendered inoperable due to the lack of some or all of such personal information.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various objects, these objects should not be limited by these terms. These terms are only used to distinguish one object from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “or” as used herein refers to and encompasses any and all possible combinations of one or more of the associated listed items. It will be further understood that the terms “comprises” or “comprising,” when used in this specification, specify the presence of stated features, integers, steps, operations, objects, or components, but do not preclude the presence or addition of one or more other features, integers, steps, operations, objects, components, or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description and summary of the invention are to be understood as being in every respect illustrative and exemplary, but not restrictive, and the scope of the invention disclosed herein is not to be determined only from the detailed description of illustrative implementations but according to the full breadth permitted by patent laws. It is to be understood that the implementations shown and described herein are only illustrative of the principles of the present invention and that various modification may be implemented by those skilled in the art without departing from the scope and spirit of the invention.

What is claimed is:

1. A method comprising:
at an electronic device having a processor and one or more sensors:
obtaining sensor data from the one or more sensors of the electronic device in a physical environment that includes one or more objects;
detecting a reflected image amongst the one or more objects based on the sensor data; and
in accordance with detecting the reflected image:
determining a context associated with a use of the electronic device in the physical environment based on the sensor data, and
presenting virtual content based on the context, wherein the virtual content is positioned at a three-dimensional (3D) location based on a 3D position of the reflected image.

2. The method of claim 1, wherein detecting the reflected image is based on tracking facial features of a user of the electronic device.

3. The method of claim 1, wherein detecting the reflected image is based on facial recognition of a user of the electronic device.

4. The method of claim 1, wherein the sensor data comprises images of a head of a user of the electronic device, and wherein detecting the reflected image is based on determining that:
the head of the user as seen in the images is rotating about a vertical axis by an amount that is double an amount of rotation of the electronic device; or
the head of the user as seen in the images is not rotating about a forward axis.

5. The method of claim 1, wherein the 3D position of the reflected image is determined based on depth data from the sensor data and the 3D location of the virtual content is based on the depth data associated with the 3D position of the reflected image.

6. The method of claim 1, wherein detecting the reflected image is based on an object detection technique using machine learning.

7. The method of claim 1, wherein the context comprises a time of day, and presenting the virtual content is based on the time of day.

8. The method of claim 7, wherein the time of day is the morning and the virtual content comprises a calendar application or a news application.

9. The method of claim 1, wherein the context comprises movements of a user of the electronic device with respect to the reflected image, and presenting the virtual content is based on the movements of the user.

10. The method of claim 1, wherein the context comprises a user interaction with the reflected image, and presenting the virtual content is based on the user interaction with the reflected image.

11. The method of claim 1, wherein determining the context comprises determining use of the electronic device in a new location.

12. The method of claim 1, wherein determining the context comprises determining use of the electronic device during a type of activity.

13. The method of claim 1, wherein determining the context comprises determining that the electronic device is within a proximity threshold distance of a location, an object, another electronic device, or a person.

14. The method of claim 1, wherein a depth position of the 3D location of the virtual content is the same as a depth of a reflected object detected in the reflected image.

15. The method of claim 1, wherein the physical environment includes one or more objects, and detecting the reflected image comprises detecting a mirror amongst the one or more objects based on the sensor data.

16. The method of claim 1, wherein the electronic device is a head-mounted device (HMD).

17. A device comprising:
one or more sensors;
a non-transitory computer-readable storage medium; and
one or more processors coupled to the non-transitory computer-readable storage medium, wherein the non-transitory computer-readable storage medium comprises program instructions that, when executed on the one or more processors, cause the system to perform operations comprising:
obtaining sensor data from the one or more sensors in a physical environment;
detecting a reflected image based on the sensor data; and
in accordance with detecting the reflected image:
determining a context associated with a use of the device in the physical environment based on the sensor data, and
presenting virtual content based on the context, wherein the virtual content is positioned at a three-dimensional (3D) location based on a 3D position of the reflected image.

18. The device of claim 17, wherein detecting the reflected image is based on tracking facial features of a user of the device.

19. The device of claim 17, wherein detecting the reflected image is based on facial recognition of a user of the device.

20. The device of claim 17, wherein the sensor data comprises images of a head of a user of the device, and wherein detecting the reflected image is based on determining that:
the head of the user as seen in the images is rotating about a vertical axis by an amount that is double an amount of rotation of the device; or
the head of the user as seen in the images is not rotating about a forward axis.

21. The device of claim 17, wherein the 3D position of the reflected image is determined based on depth data from the sensor data and the 3D location of the virtual content is based on the depth data associated with the 3D position of the reflected image.

22. The device of claim 17, wherein detecting the reflected image is based on an object detection technique using machine learning.

23. The device of claim 17, wherein the context comprises a time of day, and presenting the virtual content is based on the time of day.

24. The device of claim 23, wherein the time of day is the morning and the virtual content comprises a calendar application or a news application.

25. A non-transitory computer-readable storage medium, storing computer-executable program instructions on a computer to perform operations comprising:
obtaining sensor data from one or more sensors of an electronic device in a physical environment;
detecting a reflected image based on the sensor data; and
in accordance with detecting the reflected image:
determining a context associated with a use of the electronic device in the physical environment based on the sensor data, and
presenting virtual content based on the context, wherein the virtual content is positioned at a three-dimensional (3D) location based on a 3D position of the reflected image.
